(19) United States
(12) Patent Application Publication
(10) Pub. No.: US 2003/0093429 A1
(43) Pub. Date: May 15, 2003

(54) Data warehouse system

(75) Inventors: Norifumi Nishikawa, Machida (JP); Yuichi Yagawa, Yokohama (JP); Yasuharu Namba, Kawasaki (JP); Shoichi Minami, Yokohama (JP); Masahiro Watabiki, Yokohama (JP); Akinori Ono, Yokohama (JP)

Correspondence Address: Steve Y. Cho, Townsend and Townsend and Crew LLP, 8th Floor, Two Embarcadero Center, San Francisco, CA, 94111, US

(73) Assignee: Hitachi, Inc., Tokyo (JP)

(21) Appl. No.: 10/277,628

(22) Filed: Oct. 21, 2002

(30) Foreign Application Priority Data
Nov. 12, 2001 (JP) 2001-345520

(51) Int. Cl. G06F 7/00

(52) U.S. Cl. 707/10

(57) ABSTRACT

A data warehouse system includes a first database configured to receive first data from a first client, a data warehouse configured to receive second data corresponding to the first data from the first database after an interval to enable a second client to access the second data, and a dynamic database configured to receive third data corresponding to the first data from the first database prior to receipt of the second data by the data warehouse in order to provide the second client with access to the third data prior to the availability of the second data to the second client.

### CROSS-REFERENCES TO RELATED APPLICATIONS

The present application is related to and claims priority from Japanese Patent Application No. 2001-345520, filed on Nov. 12, 2001.

### BACKGROUND OF THE INVENTION

The present invention relates to a data storage system for storing business related data.

Due to the increased amounts of data being stored and processed today, companies or businesses store their data in operational databases that have been constructed, categorized, and formatted in a manner conducive for maximum throughput, access time, and storage capacity. The operational databases generally contain updated, modifiable data. Unfortunately, the raw data found in these operational databases often exist as rows (or records) and columns (or fields) of numbers and code that are not particularly meaningful to business analysts and decision makers. Hence, applications were developed in an effort to help interpret, analyze, and compile the data so that a business analyst may readily and easily understand it. Accordingly, the raw data is mapped, sorted, summarized, or otherwise processed to convert it into a more meaningful format before it is presented for use in a decision support system.

Extracting raw data from one or more operational databases and transforming it into useful information is one of the functions of “data warehouses” or “data marts.” Generally, in data warehouses and data marts, the data is structured to satisfy decision support roles rather than operational needs. Before the data is loaded into the target data warehouse or data mart, the corresponding source data from an operational database is filtered to remove extraneous and erroneous records; cryptic and conflicting codes are resolved; raw data is translated into something more meaningful; and summary data that is useful for decision support, trend analysis or other end-user needs is pre-calculated. In the end, the data warehouse is comprised of an analytical database containing data useful for decision support system.

Generally, a data mart is similar to a data warehouse, except that the former has a subset of corporate data for a single aspect of business, such as finance, sales, inventory, or human resources, whereas the latter generally includes the entire corporate data. However, these two terms are used interchangeably herein for purposes of simplicity. Accordingly, as used herein, either “data warehouse” or “data mart” refers to a database containing business data obtained from one or more operational databases or from one or more non-integrated business data systems, or both. The data stored in the data warehouse or data mart is typically, although not necessarily, filtered or processed to facilitate its use in a decision support system designed. In addition, the data warehouse facilitates a plurality of business users to share their data by storing their respective data in a common data warehouse, thereby enabling data sharing even between business users with different, non-integrated data systems.

One problem associated with implementing data warehouses relates to updating them with new data received in the primary databases in a non-invasive and timely manner. As used herein, the term “primary database” refers to an operational database or a database of a non-integrated business data system, or both. A batch processing is a common updating method used by the businesses, particularly in banking and finance industries. For example, Japanese Application No. 306828/1995 describes such a batch processing technology, where data is transmitted to a receiving server if a transmission condition is satisfied. The transmission condition may be a predetermined time interval or a predetermined number of input transactions received by a receiver server. The batch process is typically performed during off-hours in the middle of the night, e.g., 1 A.M. to 2 A.M, in the banking industry. Accordingly, the users of a conventional data warehouse may not have access to the most recent data in the primarily database, which can be problematic in today's dynamic business environment.

### BRIEF SUMMARY OF THE INVENTION

In one embodiment, a data warehouse system includes a first database configured to receive first data from a first client, a data warehouse configured to receive second data corresponding to the first data from the first database after an interval to enable a second client to access the second data, and a dynamic database configured to receive third data corresponding to the first data from the first database prior to receipt of the second data by the data warehouse in order to provide the second client with access to the third data prior to the availability of the second data to the second client.

In another embodiment, a management server in a data warehouse system including an operational database to store first data, a data warehouse to receive second data corresponding to the first data from the operational database, and a dynamic database to receive third data corresponding to the first data from the operational database prior to receipt of the second data by the data warehouse, the management server being configured to obtain key information from the data warehouse and store the key information into a storage area provided within the server, wherein the key information is used to purge redundant data from the dynamic database and to assist a client in determining appropriate databases to access to retrieve data requested by the client.

In another embodiment, a method of managing a management server in a data warehouse system is disclosed. The management server is coupled to a dynamic database server and a data warehouse server. The method includes transmitting a request for key information to the data warehouse server having a data warehouse. The key information provides information about data stored in the data warehouse. The key information is received from the data warehouse server. The key information received from the data warehouse is stored in a storage area.

In another embodiment, a method of managing a dynamic database server in a data warehouse system is disclosed. The dynamic database server includes a database to store data temporarily. The method includes receiving data that have been extracted from an operational database before the data are transmitted to a data warehouse server for storage in a data warehouse and inputting the data into the database provided within the dynamic database server.

In another embodiment, a data warehouse system includes an operational database to receive records on transactions that have been conducted. The record includes a transactional identifier field, an account number field, a transaction amount field, a transaction timestamp field, and a validation field. A dynamic database server includes a dynamic database and coupled to the operational database, the dynamic database being configured to receive the records from the operational database that have not been validated. A data warehouse server includes a data warehouse and coupled to the operational database, the data warehouse being configured to receive the records from the operational database that have been validated.

In yet another embodiment, a data warehouse system includes a first saving job database to receive first records on financial transactions from a first client. The first record includes a transactional identifier field, an account number field, a transaction amount field, a transaction timestamp field, and a validation field. A second saving job database receives second records on financial transactions from a second client. The second record including a transactional identifier field, an account number field, a transaction amount field, a transaction timestamp field, and a validation field. A dynamic database server includes a dynamic database and coupled to the first and second saving job databases, the dynamic database being configured to receive the records from the first and second saving job databases at predetermined instances. A data warehouse server includes a data warehouse and coupled to the first and second saving job databases, the data warehouse being configured to receive the records from the first and second saving job databases at predetermined intervals. A management server is coupled to the first and second saving job databases, the data warehouse server, and the dynamic database server and operable to retrieve key information from the data warehouse server. The key information provides information about data stored in the data warehouse and is used to assist dynamic database server in deleting redundant data stored therein.

In the data warehouse system, the predetermined instances are triggered by predetermined time intervals, inputs of a predetermined number of records in the saving job database, or user requests. The dynamic database receives records from the first and second saving job databases at different times. The first and second clients are non-integrated business systems.

### BRIEF DESCRIPTION OF THE DRAWINGS

FIG. 1 is a block diagram showing a data warehouse system according to one embodiment of the present invention;

FIG. 2 is a diagram showing flows relating the a batch process, key information handling, and dynamic database updating process according to embodiments of the present invention;

FIG. 3 is a diagram showing flows relating to a financial transaction examination program according to one embodiment of the present invention;

FIG. 4 is a diagram showing an exemplary table of data stored in the saving-job database according to one embodiment of the present invention;

FIG. 5 is a diagram showing an exemplary table of data stored in a data warehouse (DWH) prior to execution of a batch job according to one embodiment of the present invention;

FIG. 6 is a diagram showing an exemplary table of data stored in a dynamic database prior to execution of a batch job according to one embodiment of the present invention;

FIG. 7 is a diagram showing an exemplary key information stored in a storage area prior to execution of a batch job according to one embodiment of the present invention;

FIG. 8 is a flowchart relating to a database identification step according to one embodiment of the present invention;

FIG. 9 is a diagram showing an exemplary table of data stored in the DWH after execution of a batch job according to one embodiment of the present invention;

FIG. 10 is a diagram showing an exemplary table of data stored in the dynamic database after execution of a batch job according to one embodiment of the present invention; and

FIG. 11 is a diagram showing an exemplary key information stored in a storage area after execution of a batch job according to one embodiment of the present invention.

### DETAILED DESCRIPTION OF THE INVENTION

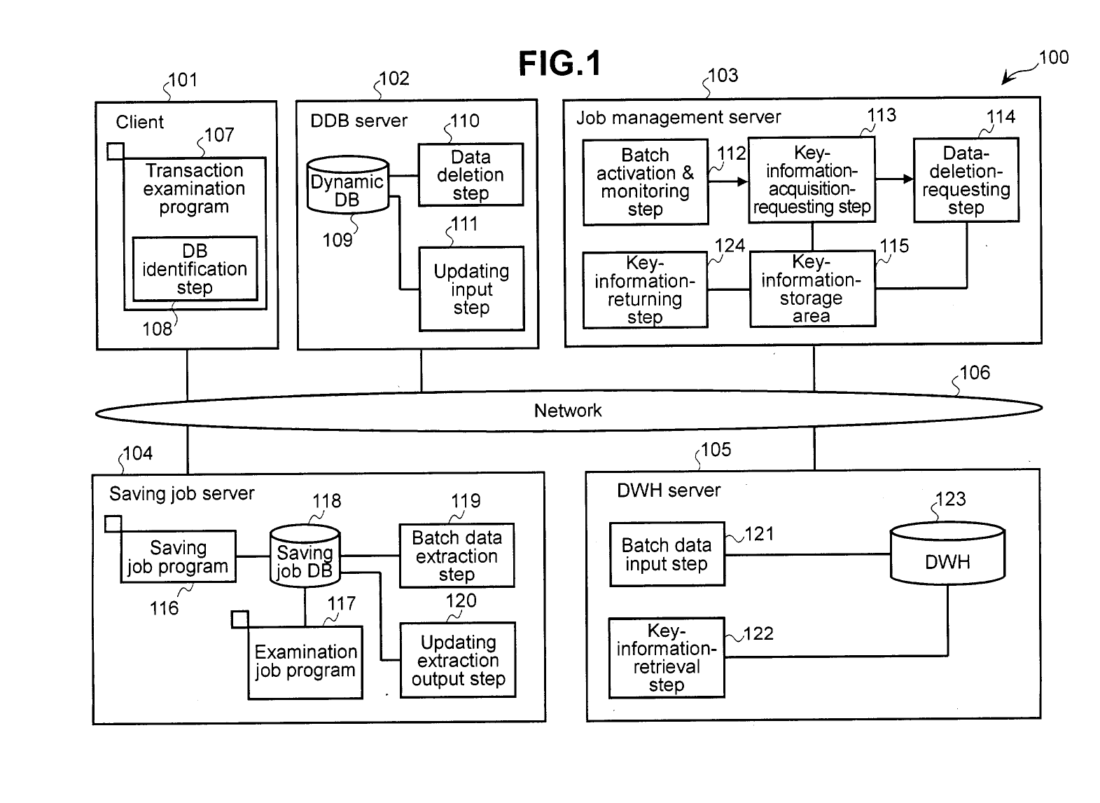

Specific embodiments of the present invention relating to banking industry are described below using FIGS. 1 to 11. The present invention, however, may be used in other business environments, e.g., in the investment sectors and customer relation management areas. Accordingly, the embodiments described below should not be used to limit the scope of the present invention.

FIG. 1 is a block diagram showing a data warehouse system 100 according to one embodiment of the present invention. The data warehouse system includes a client 101 for transmitting requests or inquiries, a dynamic database server (or DDB server) 102 for storing data on recent transactions, a job management server 103 for managing jobs in the data warehouse system, a saving job server 104 for storing data in an operational or primarily database, a data warehouse (DWH) server 105 for storing data received from one or more operational or primarily databases, and a network 106 for connecting the above devices.

As used herein, the terms “server” and “server system” are used interchangeably and each includes one or more databases, data processor, software, and the like unless otherwise stated. In one embodiment, the databases above are relational databases, and the data stored therein are in the form of tables with records or tuples and fields or attributes. Alternatively, other types of databases and data may be used to practice the embodiments of the present invention. For purpose of illustration, computer executable instructions, e.g., programs and steps, are drawn as block diagrams within the devices to which they are associated. For example, a financial transaction examination program 107 that is associated with a client 101 is drawn within the client 101 as a block diagram to illustrate the logical association between the two. However, as understood by persons skilled in the art, the program 107 may or may not reside within the client 101 or may reside partly in the client 101 and partly in another location.

The saving job server 104 includes a saving job program 116, a saving job database (DB) 118 for storing data as required by the saving job program 116, an examination job program 117 to examine or validate data supplied to the saving job DB 118, a batch data extraction step 119 for extracting and transferring data that has been examined to the DWH server 105, and an updating extraction step 120 for extracting data that has been newly inputted into the database 118 after the most recent batch extraction step 119. The updating extraction step 120 is performed at least once between two consecutive batch extraction steps. For example, if a batch extraction step is performed every day between 1-2 A.M., a new data extraction may be performed at 1-2 P.M. everyday to update the dynamic database server 102 with new data that has been received since the last batch process. The updating extraction step 120 may be performed any number of times in between two consecutive batch extraction steps according to the specific user implementation.

In one embodiment, the new data extraction step 120 is executed every few seconds, few minutes, and few hours (preferably at least once per day). In another embodiment, the updating extraction step 120 is executed when a predetermined number of new records are inputted into the database 118. In yet another embodiment, it may be prompted by a user request.

The server 102 is referred to as a “dynamic database server,” in part, because it is updated with new data or records that have been inputted into the saving job DB 118 since the last batch process. Accordingly, the server 102 has more current data than the DWH server 105 that receives data periodically from the batch extraction step 119. As used herein, the term “dynamic database” is a database that is stored with data more recent than the DWH. In the present embodiment, the dynamic database is a temporarily database that is periodically purged of redundant or old data that have been copied into the DWH. The term “dynamically” or “in real time” refers to the occurrence of an event in an interval (first interval) that is no longer than an interval (second interval) at which two consecutive batch extraction steps 119 are performed. The “first interval” can be an instantaneous time or can last as long as many hours according to the specific implementation.

The DWH server 105 includes a data warehouse (DWH) 123 to store data received from the saving job DB 118, a batch data input step 121 to store data received from the DB 118 into the DWH 123, and a key information retrieval step 122 to search the DWH 123 for key information of the data stored therein. As used herein, the term “key information” refers to information used to identify or differentiate the data or records that are stored in the DWH 123. In the present embodiment, the key information is information that identifies a record in the DWH 123 that has the most recent timestamp (“the most recent DWH record”), i.e., a record of the transaction that has occurred most recently among those stored in the DWH 123. In one implementation, the key information is the information relating to one or more fields of the most recent DWH record. In another implementation, the key information is the most recent DWH record in its entirety.

In the present embodiment, the key information is used to identify data that are useful to the DDB server 102 from those that are not (redundant data). The data that are not useful are deleted from the DDB 109. The term “key information” is also used to identify or differentiate the data or records stored in the DDB 109 from those stored in the DWH 123. That is, the key information is used to determine which databases to access in response to a data request or inquiry from a client, as explained in more detail later.

The DDB server 102 includes the dynamic database (DDB) 109, an updating input step 111 to store data received from the saving job server 104 into the DDB 109, and a data deletion step 110 to receive key information from the job management server 103 and delete data or records stored in the DDB 109 that are determined to be no longer needed by the server 102. In the present embodiment, the data being deleted by the deletion step 110 are those that have been inputted into the DWH 123 by the previous batch process. The data remaining in the DDB 109 after the deletion step 110 are the records of transaction that have occurred after the previous batch process has been performed, more specifically, new records that have been saved in the saving job DB 118 after the batch data extraction step 119 has been performed.

As explained previously, the deletion step 110 is illustrated or described as being within the DDB server 102 merely to illustrate a logical association between the deletion step 111 and the DDB server 102. However, the step 111 may or may not be stored within the DDB server. For example, the deletion step is stored in the job management server 103 according to one embodiment of the present invention. Similarly, other programs or steps illustrated in FIG. 1 are provided within particular devices to merely illustrate their logical associations, not their physical locations.

The job management server 103 includes a batch activation/monitoring step 112, a key information acquisition/requesting step 113, a data deletion request step 114, a key information returning step 124, and a key information storage area 115. The batch activation/monitoring step 112 is executed periodically to activate a batch data extraction step 119 and then monitor the termination of the extraction step 119. In one embodiment, the batch data extraction step is activated every night at 1:00 A.M. Alternatively, it could be activated at a different time or more than once within a 24-hour period. The key information acquisition/request step 113 sends requests to the DWH server 105 for key information and stores the retrieved key information in the key information storage area 115. The data deletion request step 114 obtains the key information from the storage area 115 and instructs the DDB server 102 to delete the data identified by the key information as being no longer needed in the DDB 109. The key information returning step 124, in turn, retrieves the key information from the storage area 115 and transmits it to the client 101 in response to a request received from the client 101.

The client 101 includes a transaction examination program 107 performs a financial transaction examination job and includes a database identification step 108. The DB identification step 108 sends requests to the job management server 103 for key information. The transaction examination program 107 uses the received key information to determine which database needs to nr accessed in order to obtain the desired data or records. For example, since the key information is used to identify the most recent DWH record, the identification step 108 instructs the program 107 to access the DDB 109 for more recent records and the DWH for older records.

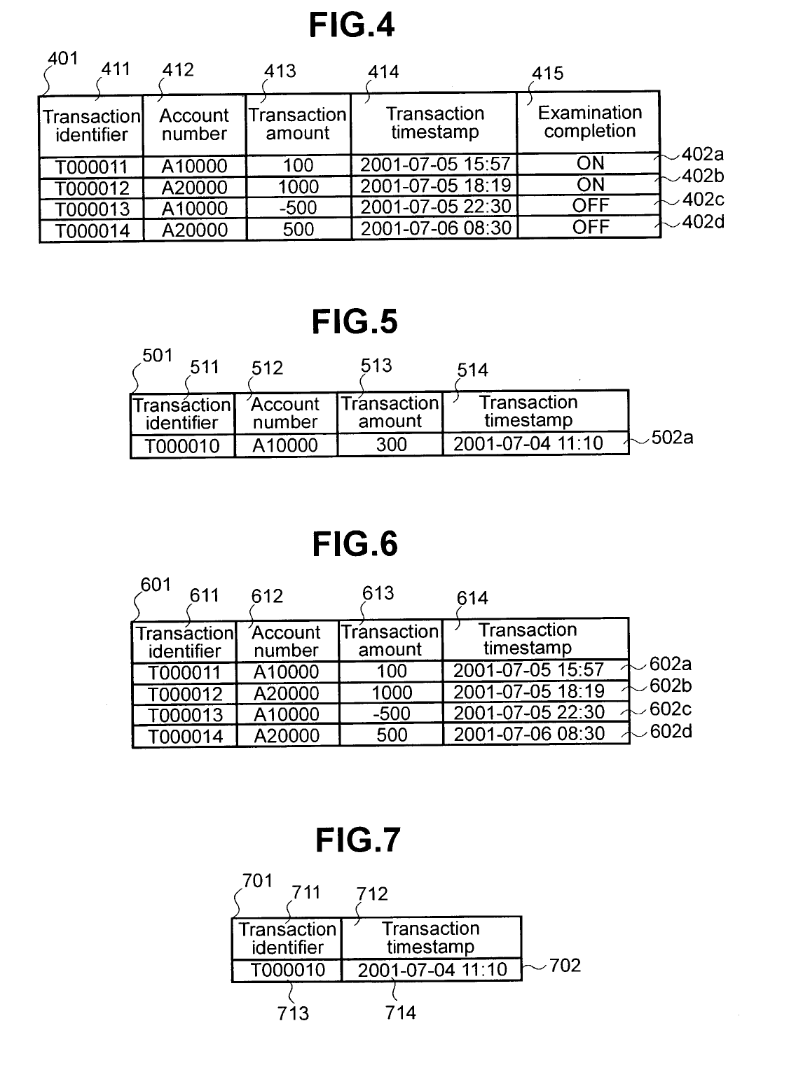

FIG. 4 shows an exemplary table 401 or data stored in the saving job DB (operational or primary database) 118. The table includes a plurality of records, e.g., records 402a to 402d, where each record represents a transaction that has been conducted. The table 401 also includes a plurality of fields, e.g., a transaction identifier field 411, an account number field 412, a transaction amount field 413, a transaction timestamp field 414, and an examination completion field 415. These fields are associated with each record. For example, the transaction identifier field includes information identifying a particular record or transaction; the account number field includes an account number associated with a record or transaction; the transaction amount field includes information about the amount of money involved in the transaction; the transaction timestamp field includes the date and time of the transaction conducted; the examination completion field includes an indication whether or not the examination or validation of the record has been performed.

In the table 401, the field 415 indicates that the records 402a and 402b have been examined, whereas the records 402c and 402d have not been examined. The records are indicated as examined if they have been validated by the examination job program 117. The validation or examination involves checking the data to determine if they are in proper format, e.g., check if an account is provided in a master account file or a transaction amount is appropriate for a given account.

FIG. 5 shows an exemplary table 501 or data stored in the DWH 123. The table includes a record 502a and a plurality of fields, e.g., a transaction identifier field 511, an account number field 512, a transaction amount field 513, and a transaction timestamp 514. Generally, the table 501 includes many records but only one record is illustrated for simplicity. The data format of the table 501 is in the format received by the batch data input step 121 from the batch data extraction step 120. As shown, the table 501 is similar in format to the table 401. However, the former does not include an examination completion field 415 unlike the latter. This field 415 is used by the data extraction step to determine which records or data are ready for extraction according to one embodiment of the present invention. Accordingly, the examination completion field 415 is not needed in the data table 501 stored in the DWH 123 since the table 501 includes the records that have been extracted already from the saving job DB 118.

FIG. 6 shows an exemplary table 601 or data stored in the DDB 109. The table 601 includes one or more records 602a-602d and a plurality of fields, e.g., a transaction identifier field 611, an account number field 612, a transaction amount field 613, and a transaction timestamp 614. The data format of the table 601 is in the format received by the updating input step 111 from the updating output step 111. As with the table 501, the table 601 does not include an examination completion field, such as the field 415, since that field is used to indicate which records are ready for data extraction in the present embodiment.

FIG. 7 shows an exemplary table 701 or data stored in the key information storage area 115 of the management server 103. The table 701 includes a record 702 and a plurality of fields, e.g., a transaction identifier field 711 and a transaction timestamp field 712. The record 702 identifies the record stored in the DWH 123 with the most recent timestamp value, i.e., the most recent DWH record, according to one embodiment of the present invention. For example, the transaction identifier and timestamp fields 711 and 712 contain values 713 and 714, respectively, that mirror or correspond to the values of the transaction identifier and timestamp fields 511 and 514. In one embodiment, the key information is used by the data deletion step 110 to delete unwanted data from the DDB 109 and the transaction examination program 107 to retrieve records from appropriate databases, as explained in more detail below.

In one embodiment, the key information is a record with a transaction identifier field and a transaction timestamp field. In another embodiment, the key information is the value 713 of the field 711 or the value 714 of the field 714. In yet another embodiment, the key information is any data or information that identifies the most recent DWH record. As seen from the above, the key information may refer to many different types of information that satisfies the definition provided in this paragraph or provided previously in page 7 or paragraph 31.

The data format of the table 701 or key information is in the data format used by various steps associated with the DWH server 105 and the job management server 103. That is, the key information retrieval step 122 uses the transaction identifier and timestamp fields to search the DWH 123 for the most recent DWH record. Alternatively, the retrieval step 122 may use only the transaction identifier field or the timestamp field to search for the most recent DWH record. Once such a record has been located, its transaction identifier and timestamp field values are retrieved and transferred to the key information acquisition/requesting step 113, which are then inputted into the transaction identifier and timestamp fields 711 and 712 of the table 701 stored in the key information storage area 115. Once stored, they are accessed by the data deletion request step 114 and the key information returning step 124, as needed, to perform appropriate actions.

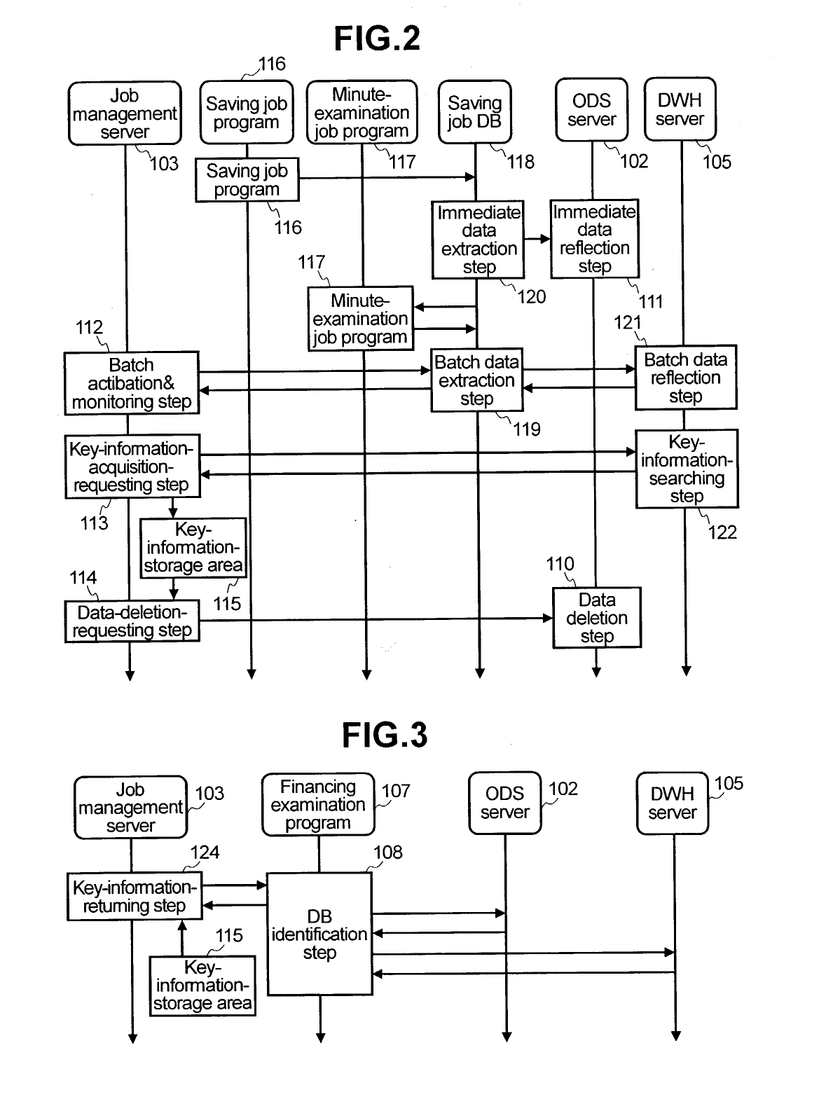

FIG. 2 illustrates data transfers amongst various components within the data warehouse system 100 according to one embodiment of the present invention. As used herein, the term “components” refers to both hardware and software within the system 100. Accordingly, the term component may refer to tangible devices (e.g., the DDB server 102) or intangible programs or steps (e.g., the data deletion step 110 and examination job program 117). FIG. 2 also shows synchronous processing flows of the DWH 105 and the DDB 109 to remove redundant or old data from the DDB 109.

Initially, the saving job program 116 inputs a record 402 to the saving job DB 118. The record conforms to the format of the table 401 of FIG. 4 and includes a plurality of fields 411, 412, 413, 414, and 415. The record 402 is received from an input client (not shown) coupled to the saving job server 104. The input client may or may not be an integrated business system with the client 101. The examination completion field 415 of the newly inputted record 402 has the value OFF to indicate that it has not been examined by the examination job program 117. Generally, there is a lag time between the time a record is inputted into the database 118 and the time the record is examined by the program 117. In one embodiment, the lag time may be few hours to dozens of hours. In FIG. 4, the records 402c and 402d represent newly added records that have not been examined by the program 117. Accordingly, the fields 415 of these records have the values OFF.

An updating extraction step 120 outputs the record 402 from the saving job DB 118 and transfers the record to an updating input step 111 associated with the DDB server 102. The input step 111 inputs the received record to the DDB 109. The table 601 and records 602 of FIG. 6 illustrate the format of the record or data stored in the DDB 109. As used herein, the term “step” is used to refer to both a particular logical sequence occurring within the data warehouse system 100 and a set of computer executable instructions. Accordingly, the term “step” could refer to a logical sequence or computer instructions themselves according to the context of its usage, which would be easily understood by a person skilled in the art.

In one embodiment, the saving job DB 118 outputs periodically a log file on the records saved or inputted therein. The updating extraction step 120 uses this log file to identify and retrieve new records inputted into the DB 118. For example, two log files that are outputted at different times may be compared to identify the records that have been newly added subsequent to the output of the previous log file. In other embodiments, the timestamp values in the field 414 or the identifier values in the field 411 may be used to identify the recently inputted records.

Referring back to FIGS. 2 and 4, a process of updating the DDB 109 is described below according to one embodiment of the present invention. The saving job DB 118 outputs an updated log file. The log file may be outputted at predetermined intervals or upon input of a predetermined number of new records, or the like. The updating extraction step 120 uses the outputted log file to identify and retrieve newly inputted records, e.g., the records 402c and 402d. The records 402c and 402d are transferred to the updating input step 111. Thereafter, these records are inputted into the DDB 109. In one embodiment, the extraction step 120 is configured to be executed each time a new log file is outputted. In other embodiments, the step 120 is executed independent of the output of the log files.

FIG. 6 illustrates the table 601 in the DDB 109 after it has been updated with the new records 602c and 602d by the input step 111. The records 602c and 602d correspond to the new records 402c and 402d that were retrieved previously by the extraction step 120. As a result, the DDB 109 is updated with new records that the clients can access promptly, i.e., without waiting for these records to be inputted to the DWH 123 by the next batch process, which may occur as long as 24 hours later according to one embodiment of the present invention.

In one embodiment, the DDB 109 is updated at least once between two consecutive batch processes. In another embodiment, the update occurs more frequently, e.g., every hour, or every minute, or every second. In another embodiment, the update is triggered if a predetermined number of new records are inputted into the saving job database 118. In yet another embodiment, the update may be triggered by a user command.

In the present embodiment, the updating extraction step 120 retrieves the records that have not been examined by the examination job program 117 since the examination is conducted relatively infrequently, e.g., every day, every night, or every two days. In other embodiments, where the examination is conducted more frequently, the extraction step 120 retrieves only the records that have been examined.

The following description explains a batch process used to copy the data 402 stored in the saving job DB 118 to the DWH server 105 and a process of synchronizing the DDB 109 and the DWH 123. The job management server 103 activates the batch activation/monitoring step 112 at a predetermined time according to one embodiment of the present invention. As a result, the batch data extraction step 119 associated with the saving job server 104 is activated. After the batch extraction activation, the step 112 monitors for the termination of the batch data extraction step 119. The termination may be indicated by a flag or signal.

During the batch data extraction step 119, all records or tuples that have been examined are extracted and transferred to the batch data input step 121. The records that have been examined or validated by the examination job program 117 are indicated as such on the examination completion field 415. That is, the field 415 is indicated as being “ON” if the corresponding record has been examined and “OFF” if it has not been examined. As used herein the, the term “record” includes tuple and other types of data according to one embodiment of the present invention. Data or record transfer here, as in elsewhere, refers to a logical event rather than a physical event. Accordingly, the extraction step 119 may transmit to the input step 121 the addresses of the records rather than actually transmitting the records themselves. Similarly, the data extraction also refers to a logical event rather than a physical event.

Referring to FIG. 4, the records 402a and 402b are extracted at the extraction step 119 since their fields indicate that they have been examined. The extracted records include the transaction identifier field 411, account number field 412, transaction amount 413 and transaction time stamp 414. The records do not include the examination completion field 415 since the field is no longer needed according to one embodiment of the present invention. The batch data input step 121 inputs the received records into the table 501 of the DWH 123.

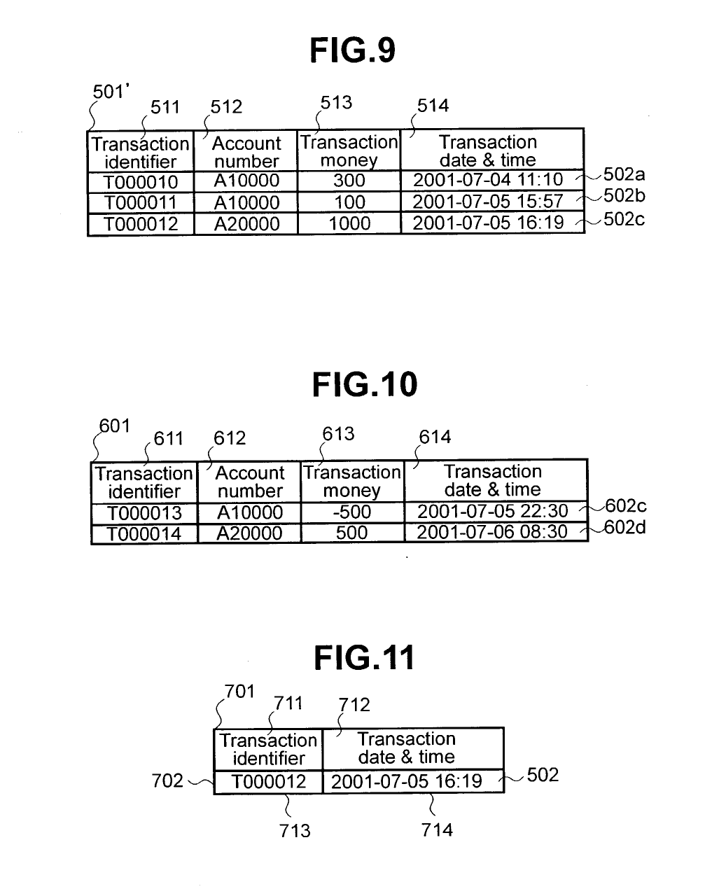

FIG. 9 shows a resulting table 501′ stored in the DWH 123. The records 402a and 402b of the table 401 of the saving job DB 118 are added to the table 501′ of the DWH 123 as the records 502b and 502c, respectively. The records 502b and 502c include a transaction identifier field 511, an account number field 512, a transaction amount 513, and a transaction timestamp 514 that correspond to the transaction identifier 411, the account number 412, the transaction amount 413, and the transaction time stamp 414 of the records 402a and 402b.

When all of the available records are inputted in the DWH 123 by the input step 121, a signal or flag is transmitted to the batch data extraction 119 to indicate the data input has been completed. The batch data extraction step 119, in turn, notifies the batch activation/monitoring step 112.

Thereafter, the job management server 103 activates the key information request step 113. The key information request step 113 causes the key information retrieval step 122 to search for key information of the records stored in the DWH 123. In the present embodiment, the key information is the transaction identifier 511 and the transaction timestamp 514 of the most recent DWH record 502, i.e., the record with the latest timestamp. For example, the key information is the transaction identifier 511 and the transaction timestamp 514 of the record 502c in the table 501′ illustrated in FIG. 9. As shown in the figure, the transaction identifier 511 and the transaction timestamp 514 are “T000012” and “2001-07-05 16:19,” respectively. Since the transaction identifier value is assigned to a transaction in sequence according to the time of the transaction, the key information may include the transaction identifier field only in other embodiments of the present invention.

Once activated, the key information retrieval step 122 searches the DWH 123 for the record with the latest timestamp and then retrieves the fields 511 and 514 associated with that record. The retrieved values or key information is transferred to the key information request step 113. The step 113, in turn, stores the received values in the key information storage area 115, thereby providing the storage area 115 with new key information.

Referring to FIG. 11, the record 702 of the table 701 is updated with the new key information. The transaction identifier and transaction timestamp fields 711 and 712 of the record 702 are updated with a value 713 (“T000012”) and a value 714 (“2001-07-05 16:19”), the values retrieved from the transaction identifier and transaction timestamp 511 and 514 of the record 502c. Thereafter, the data deletion request step 114 is activated. The key information is retrieved from the storage area 115 and transferred to the data deletion step 110 of the DDB server 102.

The data deletion step 110 uses the key information or values 713 and 714 to identify all records 602 from the table 601 of the DDB 109 having the transaction identifier and timestamp values that are less than or equal to the values 713 and 714, respectively. That is, the records 602a and 602b are deleted from the table 601. As a result, the table 601 is left with the records 601c and 601d (FIG. 10). Accordingly, the key information is used to delete redundant data or record from the DDB 109, i.e., the records that have been copied to the DWH 123 by the most recent batch process.

FIG. 3 shows exemplary process flows relating to the execution of the transaction examination program 107 according to one embodiment of the present invention. Upon receiving an inquiry, the transaction examination program 107 activates the DB identification step 108. The DB identification step 108 sends a request for key information to the key information returning step 124 of the job management server 103. The key information returning step 124 retrieves the key information from the storage area 115 and sends the information to the DB identification step 108. The identification step 108 determines which databases contain the records requested by the inquiry. Thereafter, the transaction examination program 107 accesses the DDB 109 or the DWH 123 or both according to the determination of the identification step 108.

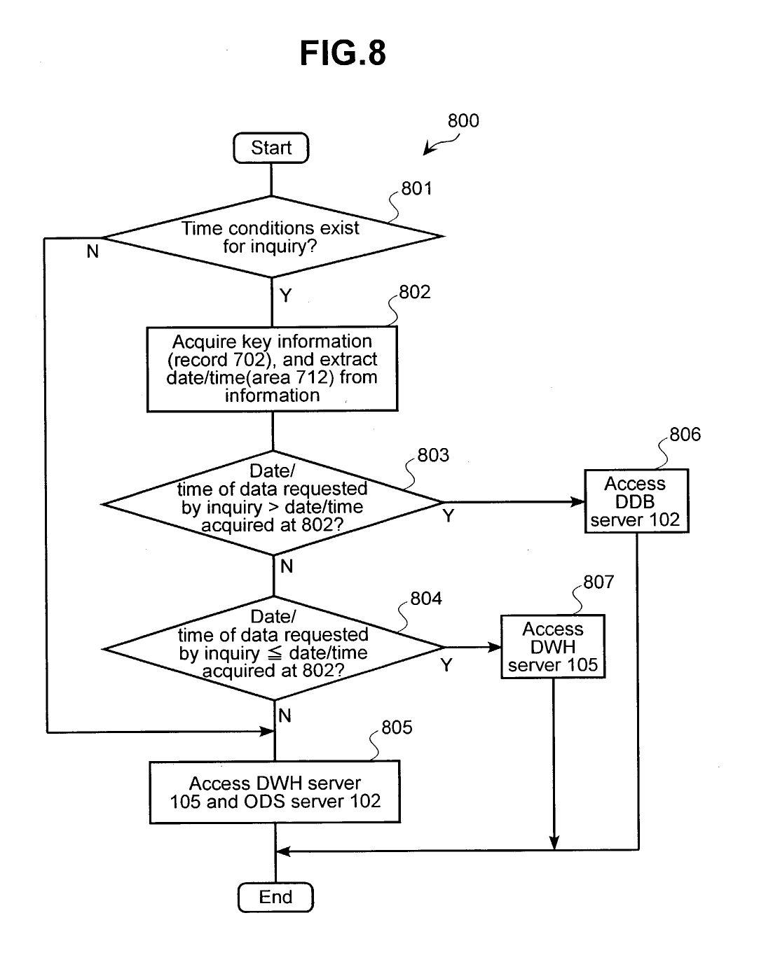

FIG. 8 is a process 800 performed by the DB identification step 108 according to one embodiment of the present invention. At step 801, an inquiry input by the transaction examination program 107 is examined to determine if the inquiry includes a time criteria or condition. As used herein, the term “time condition” refers to a search criteria relating to a point in time. The time condition specifies year, month, date, hour, and minute according to one embodiment of the present invention. In another embodiment, the time condition includes seconds or split seconds. As used herein, the term “time” refers to a time in point and may refer to date values (year, month, or day) and time values (hour or second) or solely time values.

If the inquiry includes a time condition, the value 714 of the timestamp field 712 is extracted from the key information or record 702 (step 802). Determination is made as to whether the time condition of the inquiry specifies a later time than the timestamp value 714 (step 803). That is, all of the records requested by the inquiry are transactions that have occurred after the timestamp value 714. If so, the DDB server 102 and DDB 109 are accessed to retrieve the requested records (step 806). The database access may be performed by the identification step 108, the transaction examination program 107, or another program.

If not, determination is made as to whether the time condition specifies the same or an earlier time than the timestamp value 714 (step 804). If the determination is positive, the DWH server 105 and DWH 123 are accessed to obtain the requested records (step 807). That is, all of the requested records are transactions that had occurred at the same time or before the timestamp value 714. If the determination is negative, both the DWH 123 and the DDB 109 are accessed (step 805). Referring back to the step 801, if the determination made at this step is negative, i.e., if a time condition is not included in the inquiry, the process 800 loops to the step 805 to access both of the databases 109 and 123.

Referring to FIGS. 8-11, the following describes the steps involved in processing an inquiry according to one embodiment of the present invention. The DWH 123, the DDB 109, and the storage area 115 are assumed to have the tables 501, 601, and 701, respectively.

The client 101 receives an inquiry requesting all transactions that have occurred after 2001-07-05 21:00 or 9:00 P.M. on Jul. 5, 2001. In one embodiment, the inquiry is made in a relational database format, e.g., SQL, that can be parsed by the transaction examination program 107 and the DB identification step 108. The inquiry received by the program 107 is passed on to the DB identification step 108. The DB identification step 108 examines the inquiry to determine whether the inquiry includes a time condition.

Since the inquiry includes a time condition of “Transaction date>2001-07-05 21:00,” the process 800 continues to the step 802 from step 801. At step 802, key information is retrieved from the job management server 103. The key information stored in the storage area 115 includes the identifier “T000012” or value 713 and the timestamp “2001-07-05 16:19” or value 714, as shown in FIG. 11.

The key information is examined to determine whether the time condition “2001-07-05 21:00” is later than the timestamp value 714 (step 803). Since the determination is positive, the DDB server 102 is accessed to retrieve the records of transactions that had occurred after the time condition (step 806). The DWH 123 does not need to be accessed since the key information indicates that the latest transaction record stored in the DWH 123 is “2001-070-5 16:19,” which is-a value “less than” the time condition “2001-07-05 21:00. ” The records 602c and 602d are retrieved from the DDB 109 in response to the inquiry.

The following describes the steps involved in processing an inquiry requesting records that have occurred before 9:00 P.M. of Jul. 4, 2001 (or 2001-07-04 21:00). At step 801, the process 800 continues to the step 802 since a time condition is provided in the inquiry. The key information or record 702 is retrieved from the storage area 115 (step 802). The timestamp value 714 of the key information is “2001-07-05 16:19.”

Since the time condition specifies the records of transactions that had occurred before the timestamp value 714, the determination performed at the step 803 is negative. That is, the time condition is not greater than the timestamp value of the key information. Accordingly, the process 800 continues to the step 804. Determination is made as to whether the time condition specifies the records of transactions that had occurred before the timestamp value (step 804). Since this determination is positive, the DWH server 105 is accessed to retrieve the requested records (step 807). As a result, the record 502a is obtained.

The following describes the steps involved in processing an inquiry for records of transactions that had occurred between 1:00 AM on Jul. 5, 2001 (or 2001-07-05 1:00) and 11:00 P.M. on Jul. 5, 2001 (or 2001-07-05 23:00). The process 800 flows from the step 801 to the step 802 since the inquiry includes a time condition. The timestamp value 714, i.e., “2001-07-05 16:19,” is retrieved as in previous examples. At step 803, determination is made as to whether or not the time condition is greater than the timestamp value, i.e., whether or not all the records requested have timestamp values greater than the timestamp value 714. The lower end value of the time condition, i.e., “2001-07-05 1:00,” is not greater the timestamp value. Therefore, the determination result is negative, causing the process 800 to continue to the step 804.

Determination is then made as to whether the time condition is less than the timestamp value 714, i.e., whether or not all the records requested have timestamp values less than the timestamp value 714 (step 804). This determination result is negative as well since the upper end value of the time condition is “2001-07-05 23:00.” Accordingly, both the DDB server 102 and the DWH server 105 are accessed to retrieve the requested records. The records 502b and 502c are retrieved from the DWH 123, and the record 602c is retrieved from the DDB 109.

The following describes the steps involve in processing an inquiry for all records having account number A10000. The inquiry does not include a time condition. Accordingly, the process 800 jumps from the step 801 to the step 805. Both the DDB server 102 and the DWH server 105 are accessed to retrieve the requested records. The records 502a and 502b are retrieved from the DWH 123, and the record 602c is obtained from the DDB 109. As shown in the above examples, the key information and other features of the present embodiment provide the transaction examination program 107 with a capability to intelligently select appropriate databases to access according to the inquiries received by the client 101.

The above detailed descriptions are provided to illustrate specific embodiments of the present invention and are not intended to be limiting. Numerous modifications and variations within the scope of the present invention are possible. Accordingly, the present invention is defined by the appended claims.

What is claimed is:

1. A data warehouse system, comprising:
a first database configured to receive first data from a first client;
a data warehouse configured to receive second data corresponding to the first data from the first database after an interval to enable a second client to access the second data; and
a dynamic database configured to receive third data corresponding to the first data from the first database prior to receipt of the second data by the data warehouse in order to provide the second client with access to the third data prior to the availability of the second data to the second client.

2. The data warehouse system of claim 1, further comprising:
a management server configured to issue a search request for key information stored in the data warehouse, the key information providing information on the data stored in the data warehouse.

3. The data warehouse system of claim 2, wherein the key information is used to delete a portion of data stored from the dynamic database that is redundant with a portion of data stored in the data warehouse.

4. The data warehouse system of claim 3, wherein the data deletion is performed at least once in a 24-hour period.

5. The data warehouse system of claim 2, wherein the first, second, and third data are records relating to financial transactions and the key information is an information relating to a transaction identifier field or a transaction timestamp field, or both.

6. The data warehouse system of claim 2, wherein the management server is configured to store the key information in a storage area and provide the key information to the second client upon receipt of a request from the second client, wherein the second client uses the key information to determine whether to access the data warehouse or the dynamic database or both to retrieve data requested by the second client.

7. The data warehouse system of claim 1, further comprising:
a second database configured to received fourth data from a third client, wherein data corresponding to the fourth data are subsequently inputted to the data warehouse.

8. The data warehouse system of claim 1, further comprising:
a management server configured to cooperate with the dynamic database to delete a portion of data stored in the dynamic database at designated instances, wherein the dynamic database is configured to store a plurality of records, each being associated with a transaction timestamp field, wherein the portion of data deleted at the designated instances are records with the oldest timestamp values.

9. The data warehouse system of claim 1, wherein the first database is an operational database.

10. The data warehouse system of claim 1, wherein the first client and the second client are not integrated to each other, so that the second client cannot access the first database directly.

11. A management server in a data warehouse system including an operational database to store first data, a data warehouse to receive second data corresponding to the first data from the operational database, and a dynamic database to receive third data corresponding to the first data from the operational database prior to receipt of the second data by the data warehouse, the management server being configured to obtain key information from the data warehouse and store the key information into a storage area provided within the server, wherein the key information is used to purge redundant data from the dynamic database and to assist a client in determining appropriate databases to access to retrieve data requested by the client.

12. A method of managing a management server in a data warehouse system, the management server being coupled to a dynamic database server and a data warehouse server, the method comprising:
transmitting a request for key information to the data warehouse server having a data warehouse, the key information providing information about data stored in the data warehouse;
receiving the key information from the data warehouse server; and
storing the key information received from the data warehouse in a storage area.

13. The method of claim 12, wherein the dynamic database server includes a dynamic database that temporarily stores data, the method further comprising:
providing the key information to the dynamic database server to assist the dynamic database server in deleting redundant data in the dynamic database.

14. The method of claim 12, further comprising:
providing the key information to a client to assist the client in determining whether to access the dynamic database server or the data warehouse server or both in order to retrieve data requested by the client.

15. A method of managing a dynamic database server in a data warehouse system, the dynamic database server including a database to store data temporarily, the method comprising:
receiving data that have been extracted from an operational database before the data are transmitted to a data warehouse server for storage in a data warehouse; and
inputting the data into the database provided within the dynamic database server.

16. The method of claim 15, further comprising:
receiving key information from a management server provided within the data warehouse system, the key information providing information about data stored in the data warehouse; and
deleting a portion of data stored in the database that have been determined to be stored in the data warehouse system using the key information.

17. A data warehouse system, comprising:
an operational database to receive records on transactions that have been conducted, the record including a transactional identifier field, an account number field, a transaction amount field, a transaction timestamp field, and a validation field;
a dynamic database server including a dynamic database and coupled to the operational database, the dynamic database being configured to receive the records from the operational database that have not been validated; and
a data warehouse server including a data warehouse and coupled to the operational database, the data warehouse being configured to receive the records from the operational database that have been validated.

18. The system of claim 17, wherein the dynamic database receives the records from the operational database in a real time and the data warehouse receives the records from the operational database once in a 24-hour period.

19. The system of claim 17, further comprising:
a management server coupled to the operational database, the data warehouse server, and the dynamic database server and operable to retrieve key information from the data warehouse server, the key information providing information about data stored in the data warehouse and being used to assist the dynamic database server in deleting redundant data stored therein.

20. A data warehouse system, comprising:
a first saving job database to receive first records on financial transactions from a first client, the first record including a transactional identifier field, an account number field, a transaction amount field, a transaction timestamp field, and a validation field;
a second saving job database to receive second records on financial transactions from a second client, the second record including a transactional identifier field, an account number field, a transaction amount field, a transaction timestamp field, and a validation field;
a dynamic database server including a dynamic database and coupled to the first and second saving job databases, the dynamic database being configured to receive the records from the first and second saving job databases at predetermined instances;
a data warehouse server including a data warehouse and coupled to the first and second saving job databases, the data warehouse being configured to receive the records from the first and second saving job databases at predetermined intervals; and
a management server coupled to the first and second saving job databases, the data warehouse server, and the dynamic database server and operable to retrieve key information from the data warehouse server, the key information providing information about data stored in the data warehouse and is used to assist dynamic database server in deleting redundant data stored therein.

21. The data warehouse system of claim 20, wherein the predetermined instances are triggered by predetermined time intervals, inputs of a predetermined number of records in the saving job database, or user requests.

22. The data warehouse system of claim 20, wherein the dynamic database receives records from the first and second saving job databases at different times.

23. The data warehouse system of claim 20, wherein the first and second clients are non-integrated business systems.
